(19) United States
(12) Patent Application Publication
(10) Pub. No.: US 2024/0276245 A1
(43) Pub. Date: Aug. 15, 2024

(54) A METHOD AND SYSTEM FOR MANAGING EXPOSURE GOVERNANCE CONTROL INFORMATION IN 3GPP SYSTEM

(71) Applicant: Samsung Electronics Co., Ltd., Suwon-si, Gyeonggi-do (KR)

(72) Inventor: Deepanshu GAUTAM, Bangalore (IN)

(21) Appl. No.: 18/568,034

(22) PCT Filed: Jun. 7, 2022
(86) PCT No.: PCT/KR2022/007987

§ 371 Date: Dec. 7, 2023

(30) Foreign Application Priority Data
Jun. 7, 2021 (IN) 202141025257
May 16, 2022 (IN) 20214 1025257

(51) Int. Cl. H04W 24/02; H04L 41/5009; H04W 12/08

(52) U.S. Cl. CPC H04W 24/02; H04L 41/5009; H04W 12/08

(57) ABSTRACT

The disclosure relates to a 5G or 6G communication system for supporting a higher data transmission rate. The present disclosure relates to a system and method for managing exposure governance control information in 3GPP management system. The method includes receiving, from a network entity by an EGMF, a create MOI request comprising at least one of a consumer identification (ID) with respect of each of a registered consumer with the BSS and an exposure governance control information corresponding to the consumer ID. The method further includes creating by the EGMF, based on the received createMOI request, an instance for ExposureGovernanceControl Information Object Class (IOC) comprising a plurality of IOC attributes, wherein the plurality of IOC attributes are related to the exposure governance control information. Thereafter, the method further includes sending, by the EGMF, a response to the network entity upon successful creation of the instance for ExposureGovernanceControl IOC.

### TECHNICAL FIELD

The present subject matter generally relates to exposure to governance control information in 3GPP. The present subject matter more particularly relates to exposure governance of 5G management capabilities exposed to the external third-party consumer.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5G system consists of 5G Access Network (AN), 5G Core Network and UE, in accordance with Technical Specification (TS) 23.501 [3]. 5G system is expected to be able to provide optimized support for a variety of different communication services, different traffic loads, and different end user communities. For example, the communication services using network slicing may include; V2X services. The 5G system aims to enhance its capability to meet KPIs that are required by emerging V2X applications. For these advanced applications, the requirements, such as data rate, reliability, latency, communication range, and speed, are made more stringent. 5G Enhanced Mobile Broadband (eMBB) is one of the key technologies to enable network slicing, Fixed Mobile Convergence (FMC) which includes Wireless-to-the-everything (WTTx) and Fibre-to-the-everything (FTTx), is expected to provide native support for network slicing. For optimization and resource efficiency, the 5G system selects the most appropriate 3GPP or non-3GPP access technology for a communication service, potentially allowing multiple access technologies to be used simultaneously for one or more services active on user equipment (UE), massive Internet of Things (IoT) connections. Support for Massive Internet of Things (mIoT) brings many new requirements in addition to Mobile Broadband (MBB) enhancements. Communication services with massive IoT connections such as smart households, smart grids, smart agriculture and the smart meter will require the support of a large number and high-density IoT devices to be efficient and cost-effective. Operators can use one or more network slice instances to provide these communication services, which require similar network characteristics, to different vertical industries. 3GPP TS 28.530 and 28.531 define the management of Network Slice in 5G networks. It also defines the concept of Communication Services, which are provided using one or multiple Network Slice. A Network Slice Instance (NSI) may support multiple Communication Service Instances (CSI). Similarly, a CSI may utilize multiple NSIs.

Serval type of consumers can access management capabilities provided by the management domain. The first category of the consumers is the one that is inside the operator domain but is not the part of management domain, for instance, network function in the 5GC and RAN domain. The second category of consumers is the one that is outside the operator domain, for instance, the application function deployed at the public cloud is managed and provided by a third party or external service provider. The third category of the consumers is the ones which are inside the management domain for instance EMS, and NMS.

### DISCLOSURE OF INVENTION

### Technical Problem

As per the Service Based Management Architecture (SBMA) it is possible for any network entity to consume Management Services (MnS) produced by any management entity in the Operations, Administration and Maintenance (OAM) domain. However, the visibility of the management capabilities should be restricted for the consumers which are not part of the OAM domain. An external third-party consumer such as an Edge0020Application provider should only be able to access the provisioning MnS to perform Create, Retrieve, Update, Delete (CRUD) on the related NRM (Edge) fragments only.

Furthermore, the exposure governance details (procedure flows, NRM Fragments) are not defined yet. Without the details, it is not possible to control the access of management capabilities from various consumers especially consumer which are outside of the operator domain.

Therefore, there is a need for a solution to overcome the drawbacks mentioned above.

### Solution to Problem

This summary is provided to introduce a selection of concepts in a simplified format that are further described in the detailed description of the invention. This summary is not intended to identify key or essential inventive concepts of the invention, nor is it intended for determining the scope of the invention.

The present disclosure relates to a system and method for managing exposure governance control information in 3GPP management system. The method includes receiving, from a network entity by an Exposure governance management function (EGMF), a create Managed Object Instance (MOI) request comprising at least one of a consumer identification (ID) with respect of each of a registered consumer with the BSS and an exposure governance control information corresponding to the consumer ID. The method further includes creating by the EGMF, based on the received createMOI request, an instance for ExposureGovernanceControl Information Object Class (IOC) comprising a plurality of IOC attributes, wherein the plurality of IOC attributes is related to the exposure governance control information. Thereafter, the method further includes sending, by the EGMF, a response to the network entity upon successful creation of the instance for ExposureGovernanceControl IOC.

To further clarify the advantages and features of the present invention, a more particular description of the invention will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### Advantageous Effects of Invention

In an embodiment, the method includes an ExposureGovernanceControl IOC to control the exposure of available management capabilities towards an external consumer.

As an advantage of the present subject matter, the third party or a vertical or an external can access management capabilities that are exposed by 3GPP management system. The present methodology allows access to the appropriate set of management capabilities based on the type of consumer and its contract with the operator. Additionally, the present methodology prevents exposure to the entire set of management capabilities to the consumer.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a diagram 100 depicting management of a plurality of third parties by an exposure governance, according to an existing technique.

FIG. 2 illustrates an operational flow diagram 200-1 depicting a process for managing exposure governance control information, according to an embodiment of the present disclosure.

FIG. 3 illustrates an operational flow diagram 300 depicting process of exposure governance for an external consumer is disclosed, according to an embodiment of the present disclosure.

FIG. 4 illustrates exemplary diagram of a network, according to an embodiment of the present disclosure.

FIG. 5 is a diagram illustrating the configuration of a terminal 1500 in a wireless communication system/UE according to an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

According to an embodiment of the present disclosure, a method and system for managing exposure governance in 3GPP and more particularly in 5G technology is being disclosed. In an embodiment, the method includes an ExposureGovernanceControl IOC to control the exposure of available management capabilities towards an external consumer. In an exemplary scenario, the external consumer may not be provided with the full set of management capabilities. Instead, they will only be authorized to consume a part of management capabilities as per a contract with the PLMN operator and local policies in place within the operator domain.

In an embodiment, an Object (MOI) of an Information Object Class (IOC) controls the exposure of management capabilities to third parties. Any consumer accessing management service will be subjected to exposure governance in accordance with embodiments of the present invention.

In an aspect, a Management Services (MnS) producer (exposing any MnS defined by 3GPP) is configured to consult the Exposure governance management function (EGMF) to receive a proper authorization for the consumer. Further, based on the exposure governance information provided by an EGMF, the MnS Producer either accept or reject the request. A detailed explanation of the same will be discussed in the forthcoming paragraphs.

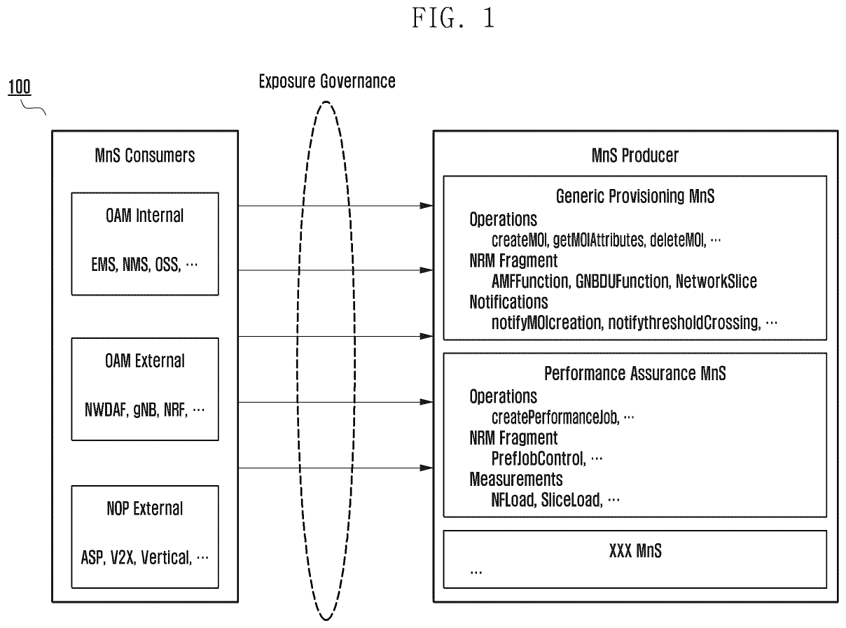

FIG. 1 illustrates diagram 100 depicting the management of a plurality of third parties by exposure governance, according to an existing technique. Referring to FIG. 1, diagram 100 depicting the management of a plurality of third parties by exposure governance is disclosed, according to an existing technique. FIG. 1 illustrates a use case to depict an authorization example. The exposure governance may define a part such as an operation, an NRM Fragment, and notifications of the management services the consumer are authorized to access.

In an embodiment, a number of the authorization examples include:
NOP External consumer ASP (Application Service Provider) is only authorized to access the following of Generic Provisioning MnS
Operations: All
NRM Fragment: EASFuncton IOC only
Notifications: createMOI
OAM External consumer NWDAF is only authorized to access the following performance assurance MnS
Operations: All
NRM Fragment: All
Measurements: sliceLoad only.
OAM Internal consumer EMS is authorized to access the full stack of MnSes.

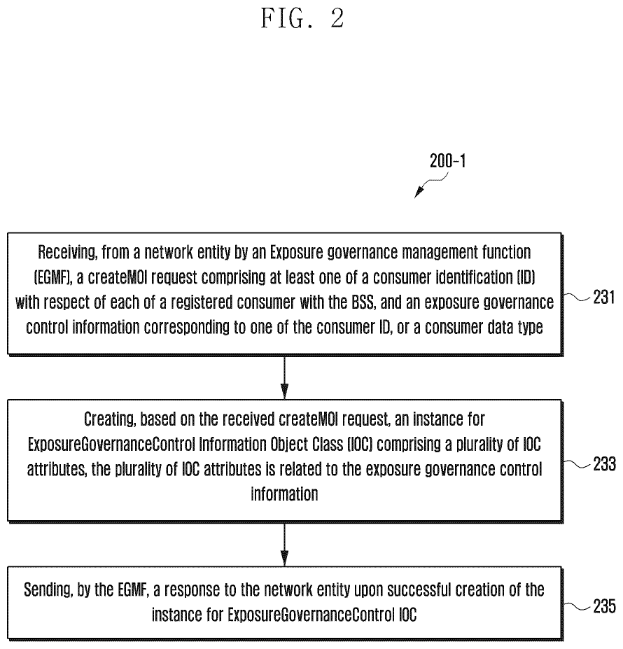

FIG. 2 illustrates an operational flow diagram 200-1 depicting a process for managing exposure governance control information, according to an embodiment of the present disclosure.

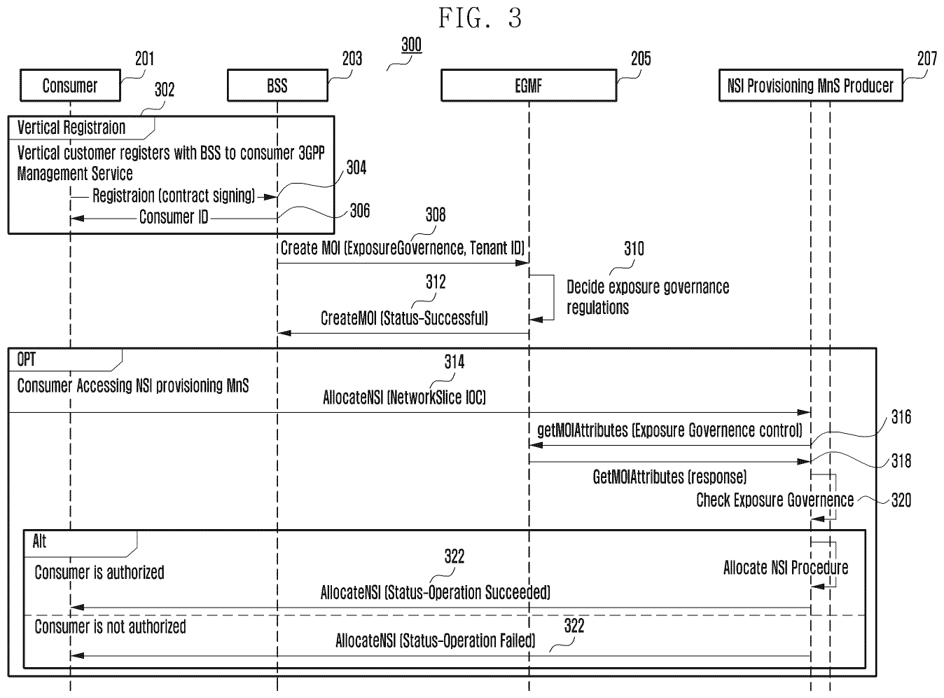

FIG. 3 illustrates an operational flow diagram 300 depicting process of exposure governance for an external consumer is disclosed, according to an embodiment of the present disclosure. According to the FIG. 3, a third-party entity may include a MnS consumer as shown in the FIG. 1 or consumers. The MnS consumer 201 may be alternatively referred as a consumer, or external consumer without deviating from the scope of the disclosure. In an embodiment of the present disclosure, an Exposure governance management function (EGMF) 205 may be any management function exposing Generic Provisioning MnS as defined in 3GPP TS 28.532 for performing basic CRUD operation of the ExposureGovernanceControl IOC. Further, in an example, a deployment may implement the EGMF 205 functionality in the MnS producer 207 itself. The consumer 201 is registered with a Business Support Systems (BSS) 203. The process flow 200-1 will be explained by referring to FIG. 3 in the forthcoming paragraphs.

According to an embodiment, the consumer 201 may not be provided with the full set of management capabilities. Instead, they will only be authorized to consume a part of management capabilities as per the contract with a PLMN operator and local policies in place within the operator domain.

In the present subject matter, initially at step 304, the consumer 201 will register with an operator BSS 203 as a consumer of the management capabilities produced by the operator 3GPP Management System. The registration is an offline process dependent on the operator policy. At step 306, in response, the BSS 203 may generate a consumer ID and the consumer type if the external consumer is a consumer, or the BSS 203 may generate a consumer ID if the external consumer is a consumer. The generated IDs may be provided to the external consumer at step 306. The BSS 203 may be alternatively referred to as a network entity without deviating from the scope of the disclosure.

According to an embodiment, at step 231, an Exposure governance management function (EGMF) 205 receives a createMOI request from the BSS 203. The createMOI request may include at least one of consumer identification (ID) with respect to each of registered consumer with the BSS 203, and an exposure governance control information corresponding to one of the consumer ID, a consumer ID, or a consumer data type. Step 231 corresponds to step 308 as shown in FIG. 3. In particular, the BSS system creates an authorization for the particular consumer in the 3GPP Management System based on the registration and operator policy. For this BSS 203 while behaving as MnS consumer sends createMOT request to the EGMF 205 at step 308. The EGMF 205 behaves as MnS producer in order to create an instance of exposure governance control IOC.

Thus, based on a registration and operator policy the BSS 203 creates an authorization for the particular consumer/consumer in the 3GPP Management system. For this, the BSS 203 while behaving as a MnS consumer sends a createMOI request to the EGMF 205. The EGMG 205 behaves as MnS producer in order to create an instance of Consumer IOC or cerate MOI for the consumer.

Accordingly, at step 233, the method 200-1, the EGMF 205 creates, based on the received createMOI request, an instance for ExposureGovernanceControl Information Object Class (IOC) for the received request. The ExposureGovernanceControl Information Object Class (IOC) includes one or more of IOC attributes that are related to exposure governance control information. Step 233 corresponds to step 308 of FIG. 3.

According to an embodiment, for creating the instance for ExposureGovernanceControl Information Object Class (IOC), the EGMF 205 determines exposure governance regulation parameters for one of the consumer ID, the consumer ID, or the consumer data type based on the received exposure governance control information. Then the EGMF 205 initiates the creation of the instance for ExposureGovernanceControl IOC having one or more IOC attributes based on the determined exposure governance regulation parameter. The step corresponds to step 310 of FIG. 3.

In particular, at step 310, the instance of exposure governance control IOC is created dictating the detailed authorization for the consumer, identified by the consumer ID or by the consumer data type provided in the request. This step included in the step 233.

According to an embodiment, the one or more IOC attributes (also defined in the Table 1 below) include at least one of:
a data type defined as an authorizedMnS. The authorizedMnS represents a list of management services and its components that the consumer is authorized to access. In particular, the authorizedMnS may include a type of MnS defined as one of PROVISIONING, FAULT_SUPERVISION, PERFORMANCE_ASSURANCE, a label that is defined as a human readable description, and a version that is defined as a version of the MnS,
a data type defined as an allowedComponentA. The allowedComponentA represents a list of operations of a Management Services (MnS), the consumer is authorized to access,
a data type defined as allowedComponentB. The allowedComponentB represents a list of IOC, related attributes and the permission for each, the consumer is authorized to access. The allowedComponentB includes a URI, the URI represents an NRM fragment (IOC),
a data type defined as a permission. The permission represents a list of attributes and its permission present in the IOC. The permission includes an attName that represents an attribute name present in the IOC, and an attPermission that represents a type of permission. Further, the type of permission includes one of readonly permission or writeable permission for the consumer,
a data type defined as an allowedComponentC. The allowedComponentC represents a list of performance measurement and a Key Performance Indicator (KPI), the consumer is authorized to collect,
a data type defined as an allowedMeasurement. The allowedMeasurement represents a list of performance measurement and the exposing entity,
a data type defined as an allowedKPI. The allowedKPI represents a list of authorized KPI the consumer is authorized to access,
a data type defined as an allowedAlarmInfo related to list of alarm info the consumer is authorized to receive. The allowedAlarmInfo includes a managedEntityAlarmInfo, the managedEntityAlarmInfo represents an alarm information authorized for the consumer,
a data type defined as an allowedNotifications. The allowedNotifications represents an URL of a notification which the consumer is authorized to subscribe for the notification.

According to an embodiment, the network entity provides one or more value to the IOC attributes via the exposure governance control information. Accordingly, at least one IOC attribute is created in the instance for ExposureGovernanceControl IOC based on the provided one more value. Further, one or more value is provided according to a data type related to the corresponding plurality of IOC attributes. MnS producer 207 ascertain one more value to the IOC attributes based on a predefined network policy. Thus, the IOC attribute that is created in the instance for the ExposureGovernanceControl IOC is based on the provided one more value by the network entity. Further, the IOC attributes are shown in the Table 1 below.

To this end, after creating the instance for ExposureGovernanceControl Information Object Class (IOC) at step 233, the EGMF 205 at step 235 sends a response to the network entity upon successful creation of the instance for ExposureGovernanceControl IOC. Step 235 corresponds to the step 312 of the FIG. 3. Thus, at step 312, the successful response of createMOI is sent to the BSS 203. Further, a detailed stepwise explanation of the FIG. 3 will be explained in the forthcoming paragraphs.

According to an embodiment the FIG. 3 provides an authorization request flow generated by consumer 201. The present subject matter provides an exposure governance control Information Object Class (IOC) controlling the exposure of the available management capabilities towards an external consumer 201 like OAM internal, OAM external, NOP external as shown in FIG. 1. The external consumer 201 may not be provided with the full set of management capabilities. Instead, the external consumer 201 is authorized to consume a part of management capabilities as per the contract with the PLMN operator and in accordance with local policies within an operator domain. Further, the reference numerals have been kept the same all over for ease of understanding. Further, the steps 304, 306, 308, 310, 312 has been explained in the FIG. 2 above. Therefore, for the sake of brevity, the explanation of the same has been omitted here.

Moving forward, later when consumer 201 tries to access any management service provided by the 3GPP Management system, it will send an appropriate request with the consumer-ID or the consumer-type assigned to it.

In an embodiment referring to FIG. 3, consumer 201 sends an allocateNSI request to a NSI provisioning MnS producer 207 at step 314. Thereafter, at step 316, producer 207 will request the exposure governance from the EGMF 205. The EGMF 205 is a management function responsible for creating the exposure governance regulation per consumer. This regulation will be consulted by every MnS producer before it accepts the request from the consumer. A request with getMOIAttributes is used for said purpose. Further in an embodiment, the EGMF 205 will send the required information at step 318. Thereafter, at step 320, the NSI provisioning MnS producer 207 checks the exposure governance regulation.

In an embodiment, where it is determined that consumer 201 is authorized to allocate an NSI, process 300 may proceed towards step 322. In an embodiment, where it is determined that the consumer is not authorized to allocate the NSI, the process may proceed toward step 324.

At step 322, the NSI provisioning MnS producer will allocate the NSI as per the procedures defined in 3GPP TS 28.531. At step 324, the un-successful response for allocateNSI will be sent to the consumer 201.

In an aspect of the present subject matter, the exposure governance control IOC with attributes related to any external consumer and their description is provided in the Table 1 below:

TABLE 1
Exposure Governance Control IOC
ExposureGovernance <<IOC>>

| | | | |
|---|---|---|---|
| >consumerID | M | 1 . . . * | The identification of the |
| | | | consumer provided at the time |
| | | | of registration with BSS |
| >consumerType | O | 1 . . . * | The type of consumer |
| | | | (OAM-Internal, OAM- |
| | | | External{gNB, CU-CP, |
| | | | NWDAF}, NOP- |
| | | | External{ASP, ECSP} ) |
| >>authorizedMnS | M | 1 . . . * | List of management services |
| <<dataType>> | | | and its capabilities the |
| | | | consumer is authorized to |
| | | | access. |
| >>> MnS Type, Label, | O | 0 . . . 1 | Type of MnS |
| Version | | | (PROVISIONING, |
| | | | FAULT_SUPERVISION, |
| | | | PERFORMANCE_ASSURANCE), |
| | | | Label: human readable de- |
| | | | scription, Version: version of |
| | | | the MnS |
| >>>allowedComponentA | M | 1 . . . * | The list of operation of the |
| | | | MnS, consumer is authorized to |
| | | | access. This will be the |
| | | | {MnSRoot} in case of |
| | | | OpenAPI implementations |
| >>>allowedComponentB | M | 1 . . . * | The list of IOC the consumer |
| <<dataType>> | | | can access. |
| >>>>uri | M | 1 | The URI of the NRM fragment |
| | | | (IOC) |
| >>>>permission | M | 1 . . . N | The list of attributes permission |
| <<dataType>> | | | present in the IOC |
| >>>>>attName | M | 1 | Attribute name present in the |
| | | | IOC |
| >>>>>attPermission | M | 1 | The type of permission |
| | | | (Readonly, Writeable |
| >>>allowedComponentC | O | 0 . . . 1 | The list of performance mea- |
| <<dataType>> | | | surement and the KPI, the |
| | | | consumer is authorized to |
| | | | collect. |
| >>>>allowedMeasurement | M | 1 . . . * | List of authorized mea- |
| <<dataType>> | | | surements |
| >>>>>managedEntity | M | 1 | Managed entity producing the |
| | | | measurement |
| >>>>>perfMeasurement | M | 1 | Measurement the consumer is |
| | | | authorized to collect. |
| >>>>allowedKPI | M | 1 . . . * | List of authorized KPI |
| <<dataType>> | | | |
| >>>>allowedAlarmInfo | O | 1 . . . * | List of alarm info the consumer |
| | | | is authorized to receive |
| >>>>>managedEntityAlarm | M | 1 | Alarm info |
| Info | | | |
| >>>allowedNotifications | M | 1 . . . * | The notifications which |
| | | | consumer is authorized to |
| | | | subscribe for. |

In the present subject matter, the MOI being the Object of IOC controls the exposure of management capabilities to the third parties or the consumers. The consumer 201 accessing management service is subjected to the exposure governance. The MnS producer 207 may consult the EGMF 205 to get the proper authorizations for the consumer and based on the exposure governance information provided by the EGMF 205, the MnS Producer 207 accepts or rejects the request.

According to an embodiment, the governance may be based on consumer/consumer type as follows:
Exposure Governance Control IOC
i. consumer/Consumer Type
1. AuthorizedMnSList
ii. consumer/Consumer Identification
1. AuthorizedMnSList
MnS Consumer Type <<dataType>>
i. OAM Internal
ii. OAM External
1. RAN (gNB, CU-CP, . . . )
2. CN (NWDAF, . . . )
3. TN (xyz, . . . )
iii. NOP External
1. ASP, ECSP Mgmt. system
AuthorizedMnSList <<dataType>>
i. MnSType, Label, Version
ii. Allowed Component A
1. OperationList (identified by {MnSRoot})
iii. Allowed Component B (identified by the URI of the NRM fragment(IOC))
1. Allowed IOC (identified by the URI of the NRM fragment(IOC))
a. AttributeName-Permission pair (AttributeX, {readonly, writable, notify})
iv. Allowed Component C
1. ManagedEntity-Measurement pair
2. ManagedEntity-KPI pair
3. ManagedEntity-AlarmInfo pair
v. Allowed Notifications
1. NotificationList

As an advantage of the present subject matter, the third party or a vertical or an external can access management capabilities that are exposed by 3GPP management system. The present methodology allows access to the appropriate set of management capabilities based on the type of consumer and its contract with the operator. Additionally, the present methodology prevents exposure to the entire set of management capabilities to the consumer.

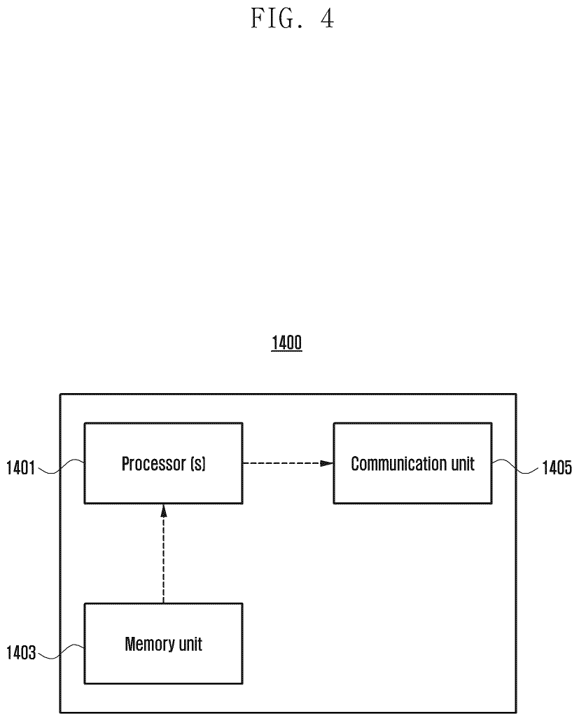

FIG. 4 illustrates exemplary diagram of a network node, according to an embodiment of the present disclosure. The network node 1400 may include a communication unit 1405 (e.g., communicator or communication interface), a memory unit 1403 (e.g., storage), and at least one processor 1401. Further, the network node 1400 may also include the Cloud-RAN (C-RAN), a Central Unit (CU), a core Network (NW), a Distributed unit (DU) or the any other possible network (NW) entity. The communication unit 1405 may perform functions for transmitting and receiving signals via a wireless channel.

For an example, the processor 1401 may be a single processing unit or a number of units, all of which could include multiple computing units. The processor 1401 may be implemented as one or more microprocessors, microcomputers, microcontrollers, digital signal processors, central processing units, state machines, logic circuitries, and/or any devices that manipulate signals based on operational instructions. Among other capabilities, the processor 1401 is configured to fetch and execute computer-readable instructions and data stored in the memory. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

The memory may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

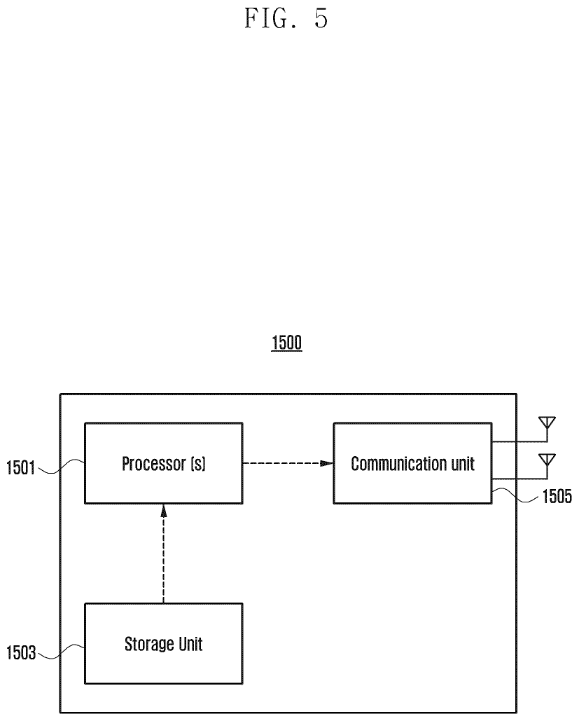

FIG. 5 is a diagram illustrating the configuration of a terminal 1500 in a wireless communication system/UE according to an embodiment of the present disclosure. The configuration of FIG. 5 may be understood as a part of the configuration of the terminal/UE 1500. Hereinafter, it is understood that terms including “unit” or “module” at the end may refer to the unit for processing at least one function or operation and may be implemented in hardware, software, or a combination of hardware and software.

Referring to FIG. 5, the terminal/UE 1500 may include a communication unit 1503 (e.g., communicator or communication interface), a storage unit 1505 (e.g., storage), and at least one processor 1501. By way of example, the terminal/UE 1500 may be a User Equipment, such as a cellular phone or other device that communicates over a plurality of cellular networks (such as a 3G, 4G, a 5G or pre-5G, 6G network or any future wireless communication network). The communication unit 1503 may perform functions for transmitting and receiving signals via a wireless channel.

Some example embodiments disclosed herein may be implemented using processing circuitry. For example, some example embodiments disclosed herein may be implemented using at least one software program running on at least one hardware device and performing network management functions to control the elements.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method performed by an exposure governance management function (EGMF) in a wireless communication system, the method comprising:
receiving, from a network entity, a create Managed Object Instance (MOI) request comprising at least one of a consumer identification (ID) or a consumer type;
generating, based on the received createMOI request, an instance for ExposureGovernanceControl Information Object Class (IOC) comprising a plurality of IOC attributes, wherein the plurality of IOC attributes is related to an exposure governance control information; and
transmitting, to the network entity, a response upon successful creation of the instance for ExposureGovernanceControl IOC.

2. The method of claim 1, wherein the generating of the instance for ExposureGovernanceControl IOC comprises:
determining exposure governance regulation parameters for one of the consumer ID, or the consumer type based on the exposure governance control information; and
initiating creation of the instance for ExposureGovernanceControl IOC having the plurality of the IOC attributes based on the determined exposure governance regulation parameter.

3. The method of claim 1, wherein the plurality of the IOC attributes includes at least one of:
a data type defined as an allowedComponentA, wherein the allowedComponentA represents a list of operations of a Management Services (MnS), the consumer is authorized to access,
a data type defined as allowedComponentB, wherein the allowedComponentB represents a list of IOC, related attributes and a permission for each, the consumer is authorized to access,
a data type defined as a permission, wherein the permission represents a list of attributes and its permission present in the IOC,
a data type defined as an allowedComponentC, wherein the allowedComponentC represents a list of performance measurement and a Key Performance Indicator (KPI), the consumer is authorized to collect,
a data type defined as an allowedMeasurement, wherein the allowedMeasurement represents a list of performance measurement and an exposing entity,
a data type defined as an allowedKPI, wherein the allowedKPI represents a list of authorized KPI the consumer is authorized to access; or
a data type defined as an allowedNotifications, wherein the allowedNotifications represents an URL of a notification which the consumer is authorized to subscribe for the notification.

4. The method of claim 3, wherein an authorizedMnS includes:
a type of MnS defined as one of PROVISIONING, FAULT_SUPERVISION, PERFORMANCE_ASSURANCE.

5. The method of claim 3, wherein the allowedComponentB includes:
a URI, the URI represents an NRM fragment (IOC),
wherein an allowedAlarmInfo includes:
an managedEntityAlarmInfo, the managedEntityAlarmInfo represents an alarm information authorized for the consumer.

6. The method of claim 3, wherein the permission includes:
an attName indicating an attribute name present in the IOC, and
an attPermission indicating a type of permission, wherein the type of permission includes one of read only permission or writeable permission for the consumer.

7. The method of claim 1, wherein the method further comprises providing one or more value by the network entity to the plurality of the IOC attributes via the exposure governance control information, wherein at least one IOC attribute from the plurality of IOC attribute is created in the instance for ExposureGovernanceControl IOC based on the provided one more value by the network entity, and wherein the one or more value is provided according to a data type related to the corresponding plurality of IOC attributes.

8. The method of claim 1, further comprising:
ascertaining one more value by an MsN producer to the plurality of the IOC attributes based on a predefined network policy, wherein at least one IOC attribute from the plurality of IOC attribute is created in the instance for the ExposureGovernanceControl IOC based on the provided one more value by the network entity.

9. An exposure governance management function (EGMF) in a wireless communication system, the EGMF comprising:
a transceiver; and
a controller coupled with the transceiver and configured to:
receive, from a network entity, a create Managed Object Instance (MOI) request comprising at least one of a consumer identification (ID) or a consumer data type;
generate, based on the received createMOI request, an instance for ExposureGovernanceControl Information Object Class (IOC) comprising a plurality of IOC attributes, wherein the plurality of IOC attributes is related to an exposure governance control information; and
transmit, to the network entity, a response upon successful creation of the instance for ExposureGovernanceControl IOC.

10. The EGMF of claim 9, wherein for generating the instance for ExposureGovernanceControl IOC, the controller is further configured to:
determine exposure governance regulation parameters for one of the consumer ID or the consumer data type based on the exposure governance control information; and
initiate creation of the instance for ExposureGovernanceControl IOC having the plurality of the IOC attributes based on the determined exposure governance regulation parameter.

11. The EGMF of claim 9, wherein the plurality of the IOC attributes includes at least one of:
a data type defined as an allowedComponentA, wherein the allowedComponentA represents a list of operations of a Management Services (MnS), the consumer is authorized to access,
a data type defined as allowedComponentB, wherein the allowedComponentB represents a list of IOC, related attributes and a permission for each, the consumer is authorized to access,
a data type defined as a permission, wherein the permission represents a list of attributes and its permission present in the IOC,
a data type defined as an allowedComponentC, wherein the allowedComponentC represents a list of performance measurement and a Key Performance Indicator (KPI), the consumer is authorized to collect,
a data type defined as an allowedMeasurement, wherein the allowedMeasurement represents a list of performance measurement and an exposing entity,
a data type defined as an allowedKPI, wherein the allowedKPI represents a list of authorized KPI the consumer is authorized to access, or
a data type defined as an allowedNotifications, wherein the allowedNotifications represents an URL of a notification which the consumer is authorized to subscribe for the notification.

12. The EGMF of claim 11, wherein an authorizedMnS includes:
a type of MnS defined as one of PROVISIONING, FAULT_SUPERVISION, PERFORMANCE_ASSURANCE.

13. The EGMF of claim 11, wherein
the permission includes:
an attName indicating an attribute name present in the IOC, and
an attPermission indicating a type of permission, wherein the type of permission includes one of read only permission or writeable permission for the consumer.

14. The EGMF of claim 9, wherein the controller is further configured to provide one or more value by the network entity to the plurality of the IOC attributes via the exposure governance control information, wherein at least one IOC attribute from the plurality of IOC attribute is created in the instance for ExposureGovernanceControl IOC based on the provided one more value by the network entity, and wherein the one or more value is provided according to a data type related to the corresponding plurality of IOC attributes.

15. The EGMF of claim 9, wherein the controller is further configured to ascertain one more value by an MsN producer to the plurality of the IOC attributes based on a predefined network policy, wherein at least one IOC attribute from the plurality of IOC attribute is created in the instance for the ExposureGovernanceControl IOC based on the provided one more value by the network entity.
